(19) United States
(12) Patent Application Publication
(10) Pub. No.: US 2008/0211840 A1
(43) Pub. Date: Sep. 4, 2008

(54) PRINTHEAD WITH ENERGY SUPPLY CONTROL AND ENERGY TRANSFER CONTROL

(75) Inventors: Thomas Michael Zevin, Valencia, CA (US); Clive Paul Hohberger, Highland Park, IL (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: ZIH Corp.

(21) Appl. No.: 11/944,180

(22) Filed: Nov. 21, 2007

Related U.S. Application Data
(60) Provisional application No. 60/866,973, filed on Nov. 22, 2006.

(51) Int. Cl. B41J 29/38

(52) U.S. Cl. 347/9

(57) ABSTRACT

Disclosed is a printhead, such as a thermal printhead. The printhead includes at least one image-forming element configured to actuate between a printing position and a non-printing position relative to the printhead. The printhead can be configured to be incorporated into a printer for processing media, such as thermal media, such that the image-forming element is configured to transfer energy to the media when the image-forming element is in the printing position, and the image-forming element is configured to inhibit energy transfer to the media when the image-forming element is in the non-printing position. Corresponding methods and printers are also provided.

### CROSS REFERENCE TO RELATED APPLICATION

This application claims the benefit of U.S. Provisional Application No. 60/866,973, filed Nov. 22, 2006, which is incorporated by reference herein in its entirety.

### FIELD OF THE INVENTION

Exemplary embodiments of the present invention relate generally to printing on thermally-sensitive paper, either directly or indirectly through the use of a thermally-sensitive ribbon intermediate in contact with plain paper or synthetic media (collectively referred to herein as “thermal media”).

### BACKGROUND

Traditional approaches often utilize thermal printheads, which are arranged as linear arrays of small, electrically resistive heating elements on a common substrate. These printheads may be swept over the thermal media, or, more commonly and as shown in FIG. 1, the thermal media 10 may be moved under the printhead 12 by use of a driven platen roller 14.

In many instances, printing speed may be limited by the ultimate temperature and rates of thermal heating and cooling of the resistive elements, as well as by the image-precision nuances associated with moving the media relative to individually heated and cooled fixed-position, closely-spaced image-forming elements. Printhead life is ultimately limited by the number of thermal shock cycles that each resistive element can withstand. Both of these factors can affect the structural design of a printhead.

Another factor limiting the printhead life typically includes the requirement that all resistive heating elements maintain a constant, uniform contact with the moving thermal media upon which the image is to be formed. Mechanical abrasion of the resistive heating element overglaze and, ultimately, the resistor itself due to the contact with the thermal media may lead to element failure. Further, while many printers are designed to include printheads corresponding to thermal media of a certain width, these printheads are often used to print on media of narrower width, thereby causing wear of the resistive heating elements due to friction from the rotating platen roller scuffing the exposed (but non-participating) resistive printing elements. Further limitations on printhead life stem from exposure of the resistive heating elements to contamination, electrostatic discharge, and potential physical damage when not printing, such as when users open the printhead assembly to load or change the thermal media.

Overall, as highlighted by the above discussion, printheads comprised exclusively of resistive heating elements are associated with several disadvantages. A further disadvantage associated with these systems relates to operational energy requirements. Specifically, printheads incorporating resistive heating elements require battery power when used in mobile or portable printers. Since the thermal printing process is typically the largest energy consumer in a thermal media printer, battery life and weight can affect and limit the utility of such portable printers, even when using relatively efficient lithium-ion batteries.

### BRIEF SUMMARY

In one aspect, a method is provided that includes controlling energy provided to an image-forming element and, perhaps separately from the controlling energy provided to an image-forming element, controlling energy transferred from the image-forming element to media in order to form an image on the media. In some cases, the controlling energy transferred from the image-forming element to media can be completely independent of the controlling energy provided to an image-forming element, while in other cases, the controlling energy transferred from the image-forming element to media can have some relationship to the controlling energy provided to an image-forming element, but without being completely dictated by that process. The controlling energy provided to an image-forming element may include controlling thermal energy provided to an image-forming element, and wherein said controlling energy transferred from the image-forming element to media includes actuating the image-forming element in order to change the distance between the image-forming element and thermal media. The actuating the image-forming element can include actuating the image-forming element into one of contact or proximity with the thermal media when at least a sub-portion of an image pixel is desired to be formed on the thermal media.

In some embodiments, the actuating the image-forming element can include independently actuating at least one of a plurality of image-forming elements. Correspondingly, the controlling thermal energy provided to an image-forming element can include individually controlling thermal energy provided to at least one of the plurality of image-forming elements, in some cases ensuring the provision of sufficient thermal energy to form at least a sub-portion of an image pixel on the thermal media with the at least one of the plurality of image-forming elements.

In another aspect, a printhead, such as a thermal printhead, is provided. The printhead includes at least one image-forming element configured to actuate between a printing position and a non-printing position relative to the printhead. The printhead can be configured to be incorporated into a printer for processing media, such as thermal media, such that the image-forming element is configured to transfer energy to the media when the image-forming element is in the printing position (e.g., by being in one of contact or proximity with the media), and the image-forming element is configured to inhibit energy transfer to the media when the image-forming element is in the non-printing position (e.g., by being sufficiently spaced apart or shielded from the media to avoid forming an image).

In some embodiments, the image-forming element can include at least one of an actuating lever, a mechanically-actuated energy shutter, or a microvalve configured to communicate with a temperature bath. In some cases, the actuating lever, a mechanically-actuated energy shutter, or a microvalve may be associated with a micro-electromechanical system (MEMS) and/or a piezoelectric actuator. In other embodiments, the image-forming element may be configured to communicate with an energy source. For example, the image-forming element can include an electrical resistor configured to communicate with a source of electrical energy. In other embodiments, the image-forming element may include an energy source. In still other embodiments, the image-forming element may include an electron beam emitter, an ion beam emitter, a gas jet, and/or a plasma jet.

In yet other embodiments, the at least one image-forming element includes a plurality of image-forming elements, with each element of the plurality of image-forming elements being configured to independently actuate between respective printing and non-printing positions. Each of the plurality of image-forming elements can be configured to be heated to a sufficient temperature and to have sufficient heat capacity to image thermal media when disposed in the printing position. Each of the plurality of image-forming elements can respectively include a mechanically-actuated energy shutter and/or a microvalve, the shutter/microvalve being configured to be selectively opened when a colored pixel is desired to be imaged on the thermal media. In some cases, each of the respective mechanically-actuated energy shutters and microvalves may be configured to actuate by an amount that is individually selectable and controllable. In still other embodiments, the thermal printhead may further include an optical device and/or contact pressure sensor, for example, for performing top-of-form detection or differential pressure control.

In still other embodiments, the image-forming element can include at least two sub-image forming elements. Each of the sub-image forming elements can be configured to form at least a sub-portion of an image pixel on thermal media. For example, each of the sub-image forming elements can be configured to contain sufficient thermal energy to form at least a sub-portion of an image pixel on thermal media.

In yet other embodiments, the image-forming element includes at least two sub-image forming elements. The sub-image forming elements can be configured such that at least one of the sub-image forming elements can be positioned in the printing position, while other sub-image forming elements are positioned in the non-printing position. In some cases, the sub-image forming elements can include multiple sub-image forming elements that can be simultaneously positioned in the printing position, while still further sub-image forming elements are positioned in the non-printing position.

In yet another aspect, a printer is provided that includes a printhead, such as a thermal printhead, and a media handling system. The printhead includes at least one image-forming element configured to communicate with an energy source and to actuate relative to the printhead between a printing position and a non-printing position. The media handling system is configured to manipulate media, such as thermal media, into an imaging position with respect to the printhead. The printer is configured such that at least one image-forming element is configured to transfer energy to the media when the image-forming element is in the printing position, and the image-forming element is configured to inhibit energy transfer to the media when the image-forming element is in the non-printing position. In some embodiments, the at least one image-forming element may include a plurality of image-forming elements that are either commonly or individually heated.

The printer may further include an energy source in communication with the image-forming element. For example, the energy source can include a system configured to support combustion of a liquefied gas, such as, for example, butane, propane, and/or natural gas; a system configured to support combustion of a liquid hydrocarbon fuel, such as, for example, gasoline, ethanol, methanol, and/or nitromethane; a source of radiant energy, such as, for example, ultraviolet radiation, infrared radiation, and/or radio-frequency energy; a convective heated gas source; and/or a plasma source. In some embodiments, the energy source may be integrated with the printhead.

### BRIEF DESCRIPTION OF THE DRAWINGS

It is believed that exemplary embodiments of the present invention will be better understood from the following description when taken in conjunction with the accompanying drawings, wherein:

FIG. 1 shows a typical arrangement of a linear thermal printhead, partially-imaged thermal media, and a driven platen roller;

FIG. 2 shows a three-element MEMS thermal printhead with lever image forming elements in accordance with one exemplary embodiment of the present invention;

FIG. 3 shows a MEMS lever image-forming element of a MEMS thermal printhead similar to that shown in FIG. 2 in crossection in the non-printing and printing positions in accordance with exemplary embodiments of the present invention;

FIG. 4 shows a MEMS flexor image-forming element of a MEMS thermal printhead similar to that shown in FIG. 2 in crossection in the non-printing position in accordance with exemplary embodiments of the present invention;

FIG. 5 shows a MEMS flexor image-forming element of a MEMS thermal printhead similar to that shown in FIG. 2 in crossection activated by an electrostatic drive while imaging thermal media in accordance with exemplary embodiments of the present invention;

FIG. 6 shows one configuration of a MEMS thermal printhead having three print lines each with a different image-forming element shape and/or spacing in accordance with one exemplary embodiment of the present invention;

FIG. 7 shows image-forming elements having sub-elements of different sizes and shapes in accordance with exemplary embodiments of the present invention;

FIG. 8 shows a MEMS thermal printhead using rotatable image-forming elements having sub-elements in accordance with an exemplary embodiment of the present invention;

FIG. 9 shows a rotatable pixel-palette image-forming element as could be used in the MEMS thermal printheads of either FIG. 6 or 8 in accordance with exemplary embodiments of the present invention;

FIG. 10 shows a rotating MEMS shutter used with a constant heat source image-forming element in accordance with one exemplary embodiment of the present invention;

FIG. 11 shows a double door MEMS shutter used with a constant heat source image-forming element in accordance with an exemplary embodiment of the present invention;

FIG. 12 shows a flexible diaphragm MEMS microvalve in the closed position used with a hot gas heat source image-forming element in accordance with an exemplary embodiment of the present invention;

FIG. 13 shows a flexible diaphragm MEMS microvalve in the open position used with a hot gas heat source image-forming element in accordance with an exemplary embodiment of the present invention; and

FIG. 14 is a schematic side view of a printer configured in accordance with another exemplary embodiment, the printer including an energy source in communication with a printhead.

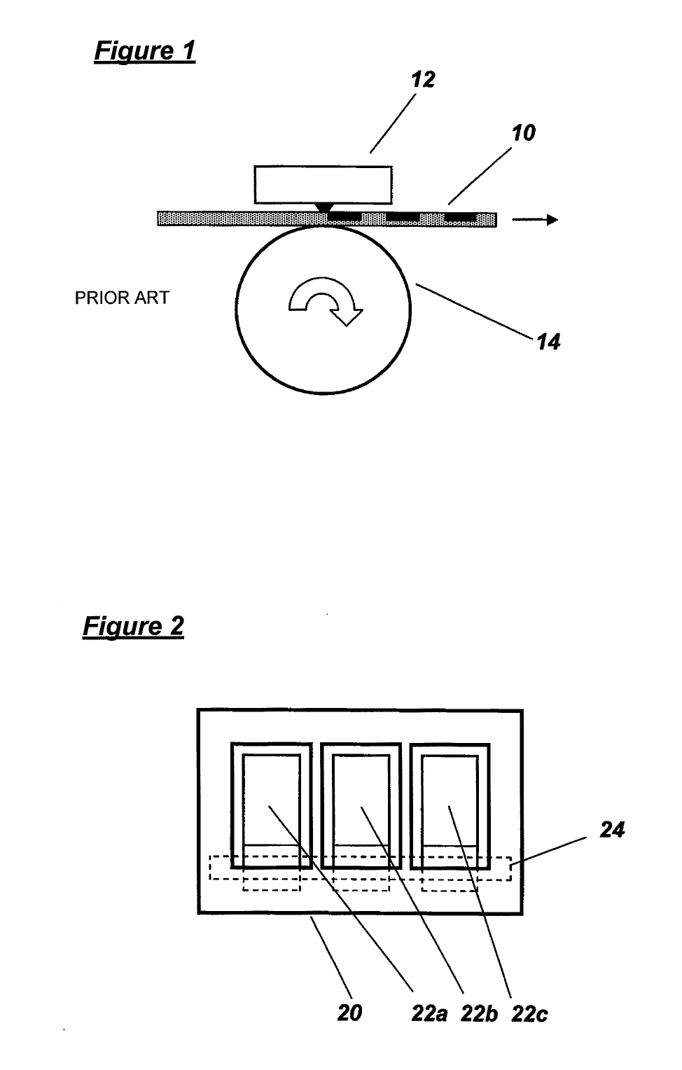

### DETAILED DESCRIPTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

According to one exemplary embodiment, imaging could be accomplished by actuating or moving the continually heated image-forming elements either onto or off of the thermal media. For example, this could be done by using a MEMS or piezoelectrically actuated lever, piston, or hammer-shaped image-forming element. FIG. 2 shows a three-element MEMS thermal printhead 20, of one exemplary embodiment, that uses three rotating lever actuators 22a, 22b and 22c, each driven by a separate unseen MEMS electrostatic or piezoelectric force transducer to rotate on shaft 24. In one exemplary embodiment, the levers at rest are always in contact with a heating chamber or buss to keep the levers at a constant temperature high enough to activate thermal media. This heating chamber or buss is sufficiently separated or insulated from the media by distance, seals, shields, baffles or other means to prevent it from imaging the media in any way other than through the actuators. In other embodiments, other manners of controlling the energy (in this case, thermal) provided to the levers/image-forming elements may be utilized, including, for example, controlling the flow of electric current to resistors situated within the image-forming elements.

Regardless of the manner utilized for controlling the energy provided to the image-forming elements and/or the heating of the image-forming elements, the movement of the continually heated image-forming elements with respect to the thermal media acts as means for controlling the transfer of energy from the image-forming elements to the thermal media. Further, this process for controlling the transfer of energy from the image-forming elements to the thermal media is independent of the control of the temperature of the image-forming elements or the provision of energy thereto.

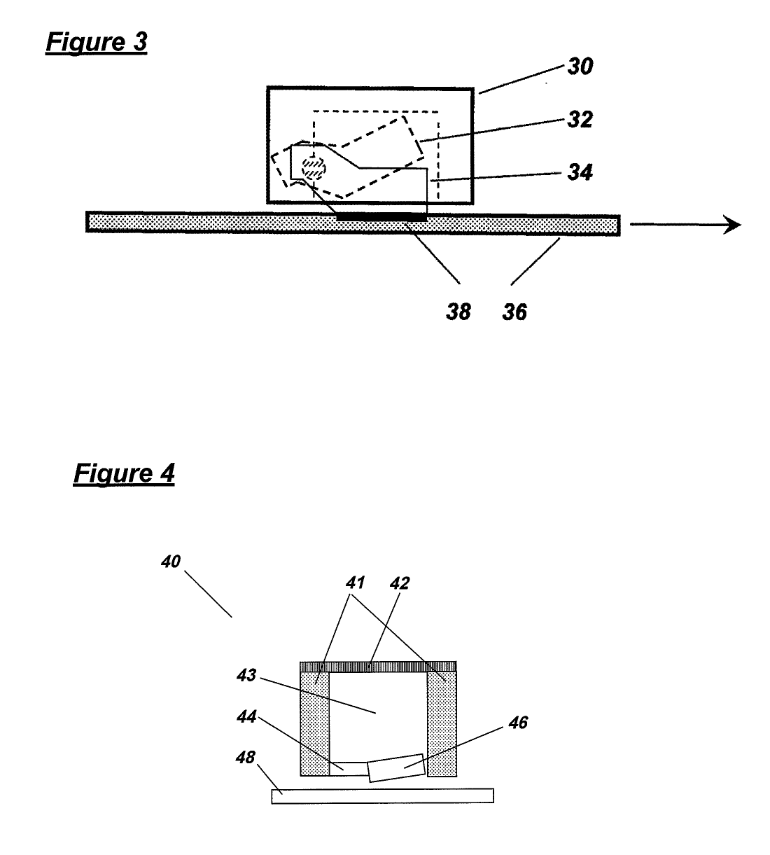

FIG. 3 shows one of the heated lever actuators in a cross-sectional view of a printhead 30 according to one exemplary embodiment. When a pixel is to be printed, a force transducer, not shown, moves the lever from its retracted position 32 (i.e., the “non-printing position”) to deployed position 34 (i.e., the “printing position”) so that the heated surface of the lever contacts the thermal media 36 forming an image 38. It is noted that the thermal media 36 is in the so-called “imaging position” in FIG. 3, meaning the media is positioned to be imaged upon by the printhead 30. Further, in some embodiments, it may not be necessary for the lever to contact the thermal media 36 when in the printing position, but rather the lever need only move into proximity with the thermal media in order to effectively transfer energy to the thermal media, either through conduction, convection, or radiation. Generally, the printing position should be understood to refer to the position (or configuration) of an image-forming element in which it may effectively transfer energy to media being imaged. Correspondingly, the non-printing position should be understood to refer to a range of configurations in which an image-forming element does not effectively transfer energy to media. It is noted that, in some cases, actuation between a printing position and a non-printing position may involve only an internal reconfiguration of the image-forming element (such as the opening of a valve or shutter) and may not involve any physical relocation of the entire image-forming element. Further, as will be discussed further below by way of example, in some embodiments, the image-forming elements may assume the non-printing position in a default or “rest” state and may be actuated from that “rest” state into the printing position, while in other embodiments the printing position may be the “rest” state for the image-forming elements.

FIG. 4 shows a second exemplary embodiment with one of the heated MEMS flexor actuators in a cross-sectional view of a printhead 40. When the charges are arranged on the conductor 46 and electrode 42 such that there is no electrostatic force on flexor 44 (e.g., when at least one of the conductor and the electrode have no net charge), the flexor remains in the rest position. The conductor 46 attached to flexor 44 is in communication with an energy source, in the illustrated case being heated by a temperature bath in the form of a hot gas 43 to a constant temperature sufficient to enable imaging of thermal media 48 in contact or close proximity therewith. The temperature bath is insulated or sufficiently separated directly from the media by means not shown such that only either flexor 44 or conductor 46 are allowed access to the media in order to form images as just described. In other embodiments, temperature could be controlled, for example, through resistive or inductive heating, through exothermic chemical reactions, etc., any of which could be used to heat the flexor 44 and conductor 46 individually or could be used to form a temperature bath.

FIG. 5 shows one of the heated MEMS flexor actuators in a cross-sectional view of the printhead 40 according to the second exemplary embodiment. When a pixel is to be printed both the conductor 46 and electrode 42 are given similar electric charge, and the repulsive electrostatic force 50 bends flexor 44 to deployed position so that the pre-heated surface of the attached conductor 46 moves into proximity with the thermal media 48 in order to effectively transfer energy to the thermal media, either through conduction, convection, or radiation forming an image 52.

The decoupling of image-forming element heating process from image-forming timing can have an advantage of achieving more precise transitions between image edges or image region transitions, and thus either improved print quality or faster printing speed for the same image quality. Therefore, some exemplary embodiments of the present invention may enable printing more precise image edges that lead to higher quality images. Such higher quality images can be useful in a variety of applications, such as in forming rotated barcodes, grayscale picture images or small print, or in the use of thermally challenging media such as synthetic materials or thick paper tags.

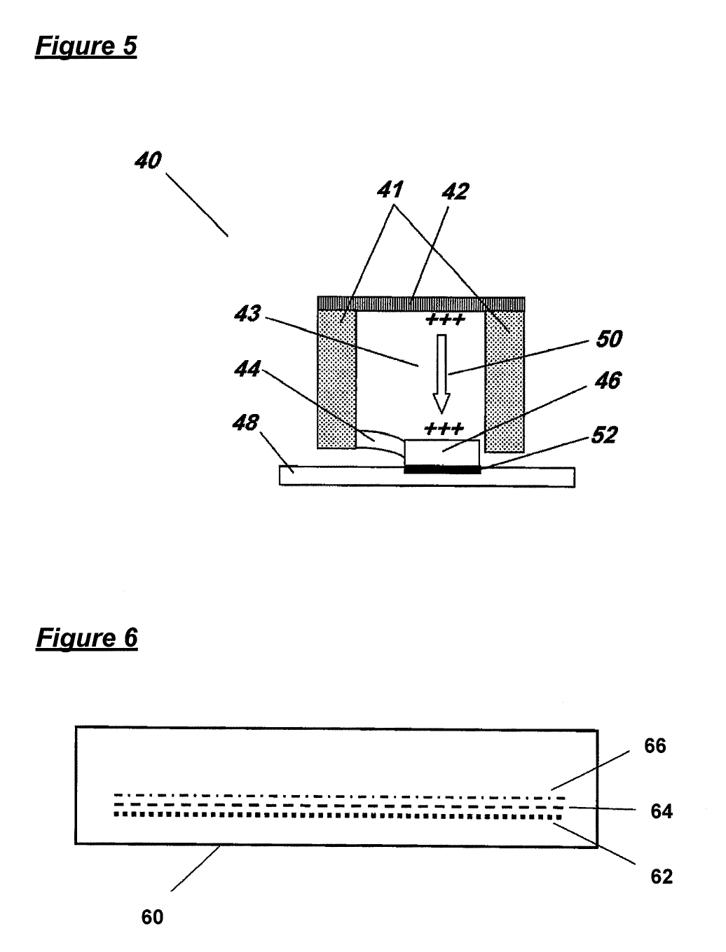

FIG. 6 illustrates a MEMS thermal printhead 60 of another exemplary embodiment of the present invention. As shown, the MEMS thermal printhead 60 of this embodiment may contain multiple MEMS-actuated print lines of image-forming elements 62, 64 and 66 having different pixel shapes. The different lines and pixel shapes allow a variety of print line positions and pixel shape or density as well as area of heat-contact advantages. Multiple dot resolutions could also be accomplished with one MEMS thermal printhead

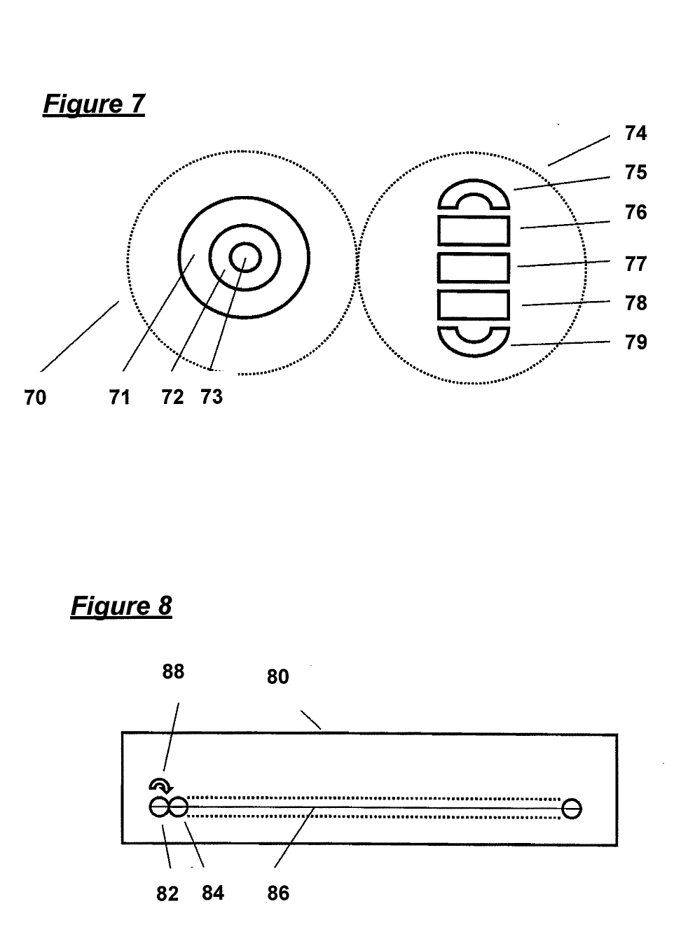

FIG. 7 illustrates a few different shapes of image-forming elements which might be employed in a MEMS thermal printhead 80 in FIG. 8 in accordance with exemplary embodiments of the present invention. According to this exemplary embodiment, each pixel in the printhead 80 is formed by multiple, independently actuated MEMS image-forming sub-elements such as shown in group 70 comprising concentric pistons 71, 72 and 73, which allow printing of dots of different diameter, or rings. Group 74 comprising image-forming sub-elements 75, 76, 77, 78 and 79 similarly allows for printing different image shapes and sizes. According to one exemplary embodiment, image-forming elements are typically kept hot and axially actuated into or out of contact with the thermal media, here assumed normal to the view. Additionally, sub-elements may be heated or not heated depending on the advantage desired for timing, energy, or power management and contact area.

If in printhead 80, each pixel 82, 84 etc. along print line 86 is rotatable in the direction shown 88, then a pixel-palette 90 of image-forming sub-elements 94, 95, 96 and 97 such as shown in FIG. 9 might be used, which could be rotationally selected via MEMS rotation 92 of each pixel-palette 90. Matching elements can be placed on opposite sides of each pixel palettes' rotational axis or on radial lines from the center thereof. Alternatively, the position of each palette can be forward or backward on the print-line to achieve desired spacing of elements in lieu of palette diameter or to better manage platen or transfer ribbon contact with image forming elements depending upon characteristics of different properties of a variety of media.

In another exemplary embodiment, heater elements may be used that could be either radiative energy such as infrared light or radio-frequency energy; convective energy sources such as heated gases, micro-gas or plasma jets; or even energetic electron or ion particle beams. These could be of extended size (such as the length of the print line) with each image-forming element having a separate shutter control to selectively block or alternatively convey the energy onto the thermal media to image it. The pixel area exposed can be varied via MEMS shutters or microvalves. It is noted that, in this case, an open shutter or microvalve would be a printing position, and a closed shutter or microvalve would be a non-printing position.

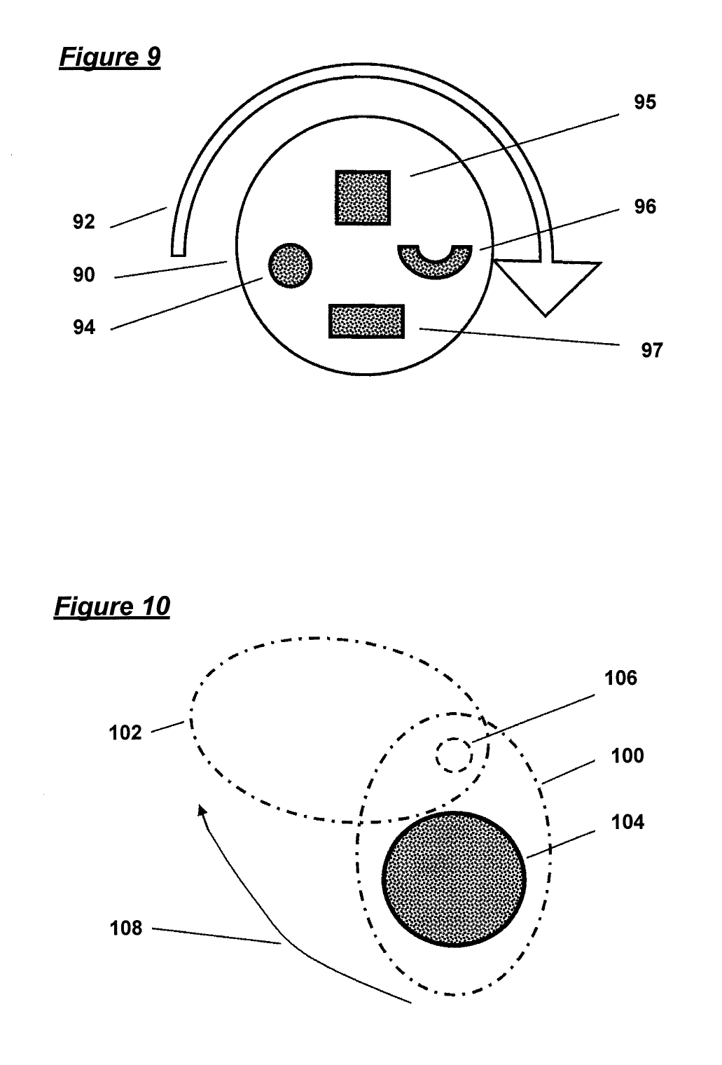

In FIG. 10, which illustrates a rotating MEMS shutter that may be used with a constant heat source image-forming element in accordance with one exemplary embodiment of the present invention, heat element 104 may be concealed, partially exposed or fully exposed by “MEMS” shutter 100, shown in the closed position. When shutter 100 is rotated in the direction 108 about axis 106 by an unseen MEMS actuator from the closed position 100 to the open position 102, then the heat source 104 is directly exposed to the thermal media. According to this exemplary embodiment, the shutter open time thus controls the amount of heat transferred to the thermal media.

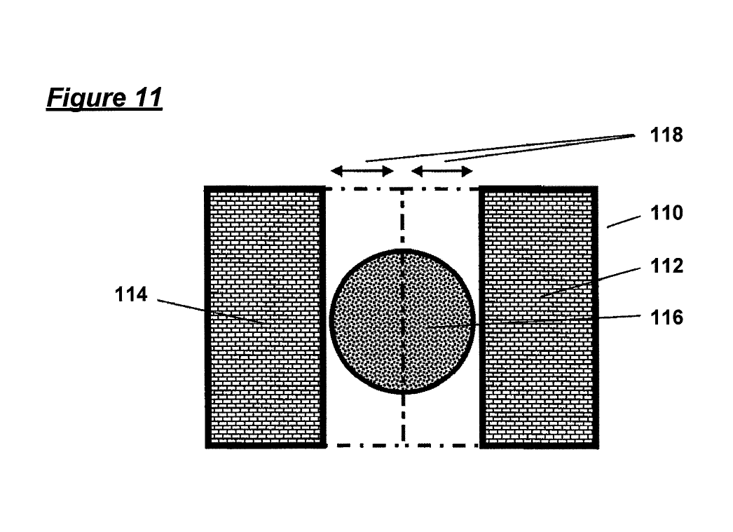

Shutters can have single or multiple elements. For example, the shutter could even be a “MEMS” version of a camera aperture iris. In FIG. 11, a double door shutter 110 of another exemplary embodiment is formed from doors 112 and 114, both shown in the open position using unseen MEMS actuators which move the doors along the directions of motion 118. When shut, the shutter 110 blocks heat from heat source 116 from activating the thermal media.

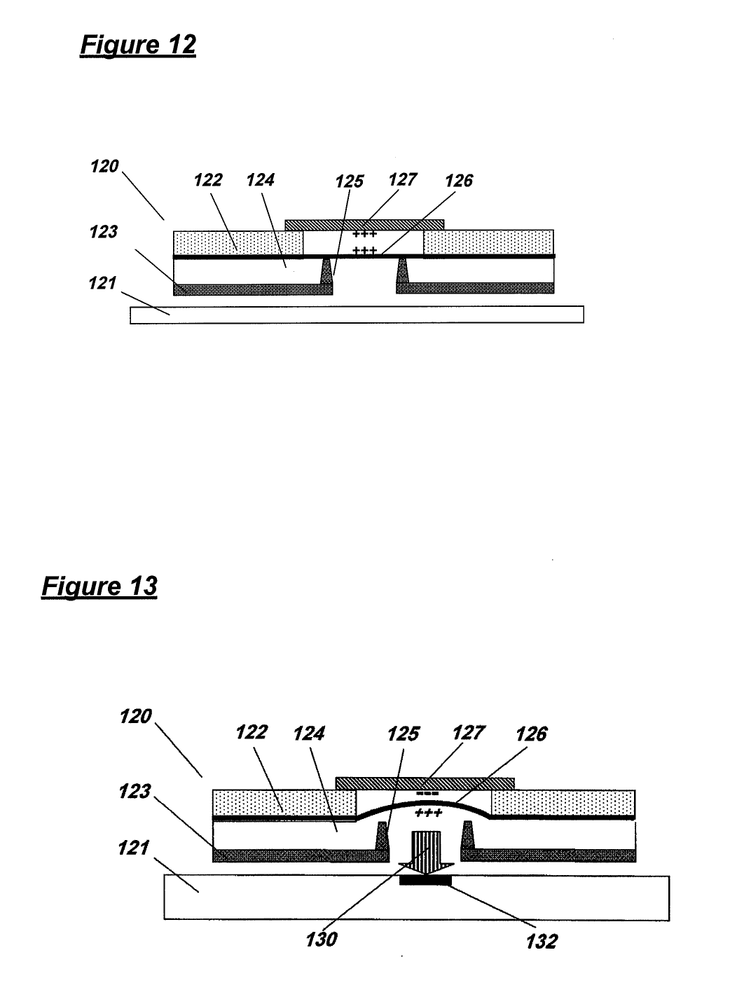

In FIG. 12, a flexible diaphragm MEMS micro-valve 120 is shown controlling the hot gas flow impinging onto thermal media 121. This structure is formed from top plate 122 and bottom plate 123 forming a plenum 124 filled with a hot gas temperature bath at a temperature above that needed to image the thermal media 121. An electrically-conductive micro-machined flexible diaphragm 126 in the rest position closes off the gas-filled plenum from the orifice 125 when no or insufficient electrostatic force is exerted on the diaphragm due to the charges distributed between diaphragm 126 and electrode 127. If additionally needed to overcome the hot gas pressure in plenum 124, electrostatic charge of like polarity may be placed on diaphragm 126 and electrode 127 to create additional electrostatic forces to hold diaphragm 126 closed against orifice 125.

In FIG. 13, when a voltage is applied to electrode 127 creating a potential difference between it and diaphragm 126, the electrostatic attraction force causes diaphragm 126 to bend inward, which allows hot gas 130 to flow from plenum 124 through orifice 125, impinging on the thermal media 121, and causing a thermochromic color change 132 in the thermal media 121.

The shutters or microvalves could open or close to individual and different sizes or at slightly different rates to add fine control of differential pixel detail never before possible with static shape and/or area pixel elements.

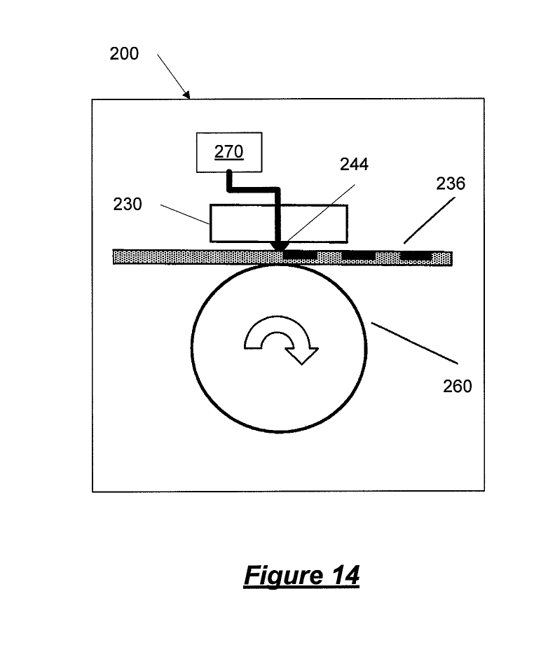

Referring to FIG. 14, therein is shown a schematic side view of a printer 200 configured in accordance with another exemplary embodiment. The printer 200 includes a thermal printhead 230 and a media handling system 260. The media handling system 260 can be configured to manipulate thermal media 236 into an imaging position with respect to the printhead 230. For example, the media handling system 260 may include a platen roller that moves thermal media through the printer 200.

The thermal printhead 230 includes an image-forming element 244 (or, in some cases, multiple image-forming elements) configured to actuate relative to the printhead between a printing position and a non-printing position. The image-forming element 244 can also be configured to communicate with an energy source 270 that supplies energy to the image-forming element. For example, the energy source 270 can include a system configured to support combustion of a liquefied gas, such as, for example, butane, propane, and/or natural gas; a system configured to support combustion of a liquid hydrocarbon fuel, such as, for example, gasoline, ethanol, methanol, and/or nitromethane; a source of radiant energy, such as, for example, infrared radiation and/or radio-frequency energy; a convective heated gas source; and/or a plasma source. The image-forming element 244 could be structured so as to be interoperable with whatever energy source was employed, the image-forming element being configured so as to effectively transfer energy to media 236 when the image-forming element is moved into the printing position and the media is in the imaging position.

MEMS thermal printheads of either the contact or noncontact exemplary embodiments could enable gray scale and color printing through control of the image forming element contact time with the thermal media, and thus the amount of heat energy transferred. An alternate approach for controlling contact time is to pulse-actuate the elements multiple times for specific portions of images such that more energy is applied to one spot on the media than others by using multiple, extremely-fast actuation pulses for pixel optical density control, commonly referred to as “gray scale”.

Using appropriate thermal media, such as monochrome dye diffusion thermal transfer ribbons and coated receiving paper, a gray scale may be printed by controlling the image-forming element contact time and thus the energy per pixel transferred. In this manner, a wide color gamut may be printed using gray scale printing combined with standard additive (Red-Green-Blue) or subtractive color forming (Cyan-Magenta-Yellow) overprinting of each pixel.

In traditional thermal printing, individual element shapes, physical areas and resolutions are single and constant for each pixel of any imaging head and are historically a compromise single size/area for all purposes. Resolution or image density, pixels per area, on image forming surface is typically fixed for imaging devices and traditionally requires separate devices for any specific resolution. In traditional thermal printing, different print speeds become limited by these traditional approaches.

Yet another possible advantage of a MEMS based thermal printhead of exemplary embodiments may be to create pixels that are made up of multiple but individually actuated or variable-magnitude actuated sub-portions or elements of different size, relative position and shape, where the image position and resolution can be individually customized at any particular time. This exemplary embodiment may give the ability to have optimized pixel shape when printing different types of images and to have different pixel shapes and even resolutions for different portions of images depending on the surrounding thermal needs or history. By combining continuously variable resolutions using individual pixel sub portions that are variably actuated and a media drive system such as a continuously variable belt transmission, an image forming device can therefore have variable resolution capability.

Thus, according to some exemplary embodiments of the present invention, a single image-forming device can then have fast speed and lower resolutions when printing non-demanding images such as larger text and then use higher resolution on demand for barcodes or demanding images by changing speed and pixel density with such combinations.

A further advantage of some exemplary embodiments is to combine either image density, local contact pressure measurement, or top-of-form detection with each pixel, or perhaps groups of pixels, utilizing MEMS technology. Pressure measurement and optical devices are currently produced with MEMS and at MEMS scale, and a MEMS thermal print head could integrate printing and sensing devices to further optimize and control image quality, uniformity and relative position including integral top-of-form position control within the head itself. Traditional thermal printers typically do not control all of these parameters and currently use additional systems outside the print head to control at least some of them. Integrating these parameters within the head itself enables uniformity control and miniaturization of printers never before possible with traditional printers.

According to some exemplary embodiments of the present invention, the heating and cooling processes of image-forming elements are separated from the process of transferring the image-forming elements' heat to the thermal media. In one exemplary embodiment, this may be done by replacing the heating and cooling of resistive heating elements in continual contact with the thermally-sensitive paper or ribbon with mechanical actuation of the continually heated image-forming elements against the thermal media only when a colored image pixel is desired to be formed at the location of that image-forming element.

By using different heat sources and at least partially decoupling the heating/cooling timing, exemplary embodiments allow much higher temperature image-forming elements, thus permitting thermal printing on other than traditional thermal media, including the use of thermal transfer ribbons and hot-stamping ribbons. An additional use of exemplary embodiments may be to have two or more different groups of image-forming elements that may be individually actuated, available at two or more different temperatures.

In particular, as is known by those of ordinary skill in the art, it can take significant time to heat and especially to cool traditional electrically resistive thermal printhead elements to form precise images as the thermal media and image-forming printhead are moved relative to each other. This limits the printing speed at which acceptable image quality can be obtained. According to one exemplary embodiment, each image-forming element is always heated to a constant temperature, thus eliminating the thermal cycling, or thermal blooming, that occurs in resistive print heads that requires print image-specific pixel history control compensation of the power supplied to each resistive element. The “always hot” approach of one exemplary embodiment can lead to a more stable temperature control of groups of image-forming elements than possible when constantly heating and cooling them individually.

Use of a common alternate heat source such as a hot gas temperature bath for all image-forming elements rather then individual electrically-resistive heating elements also allows for alternate energy sources to provide the primary power for a thermal printer. For example, liquefied gases, such as butane and propane; gasoline; nitromethane; and alcohols, such as methanol, ethanol, offer much higher energy densities per unit mass or per unit volume than offered, for example, by more conventional rechargeable lithium-ion or nickel metal hydride batteries, allowing development of lighter and/or more compact thermal printers.

Liquefied butane is particularly attractive as it is commonly available packaged as small, inexpensive disposable cartridges which are generally recognized as safe for use in small hand-held and portable tools and appliances. Liquefied butane has an energy density approximately 40 times that of current Li-ion batteries. Therefore, a MEMS printhead using a hot combustion gas as the heat source offers some interesting advantages, especially in portable, wearable and fixed-mobile thermal media printers.

As those of ordinary skill in the art will recognize, various design and manufacturing methods using MEMS technology (i.e., a technology that combines computers with tiny mechanical devices such as sensors, valves, gears, mirrors, and actuators embedded in semiconductor chips) are known that can be used to manufacture the MEMS-based printheads of exemplary embodiments of the present invention described above. For example, the manufacturing methods described in U.S. Pat. No. 5,955,817 entitled “Thermal Arched Beam Microelectromechanical Switching Array,” or U.S. Pat. No. 5,994,816 entitled “Thermal arched beam microelectromechanical devices and associated fabrication methods,” could be employed. The contents of these two patents are hereby incorporated herein by reference in their entirety. Other MEMS design and fabrication techniques are well known, and other references available to those of ordinary skill in the art include: “Microstereolithography and other Fabrication Techniques for 3D MEMS,” V. K. Vardan, X. Jiang and V. V. Vardan; “Mems/Nems: (1) Handbook Techniques and Applications Design Methods, (2) Fabrication Techniques, (3) Manufacturing Methods, (4) Sensors and Actuators, (5) Medical Applications and MOEMS,” Cornelius T. Leondes; “Microsensors MEMS and Smart Devices,” J. Gardner, V. K. Vardan and O. Awadelkarim; and “Modeling MEMS and NEMS,” J Pelesko and D. Bernstein; the respective contents of which are incorporated herein by reference in their entireties.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and the modifications and other embodiments are intended to be included within the scope of the appended claims. Although specific terms are employed herein, they are used in a generic and descriptive sense only and not for purposes of limitation.

What is claimed is:

1. A method comprising:
controlling energy provided to an image-forming element; and
controlling energy transferred from the image-forming element to media in order to form an image on the media.

2. A method according to claim 1, wherein said controlling energy transferred from the image-forming element to media in order to form an image on the media includes controlling energy transferred from the image-forming element to media separately from said controlling energy provided to an image-forming element.

3. A method according to claim 1, wherein said controlling energy transferred from the image-forming element to media in order to form an image on the media includes controlling energy transferred from the image-forming element to media independently of said controlling energy provided to an image-forming element.

4. A method according to claim 1, wherein said controlling energy provided to an image-forming element includes controlling thermal energy provided to an image-forming element, and wherein said controlling energy transferred from the image-forming element to the media includes actuating the image-forming element in order to change the distance between the image-forming element and the media.

5. A method according to claim 4, wherein said actuating the image-forming element in order to change the distance between the image-forming element and the media includes actuating the image-forming element into one of contact or proximity with the media when at least a sub-portion of an image pixel is desired to be formed on the media.

6. A method according to claim 4, wherein said actuating the image-forming element in order to change the distance between the image-forming element and the media includes independently actuating at least one of a plurality of image-forming elements, and wherein said controlling thermal energy provided to an image-forming element includes individually controlling thermal energy provided to at least one of the plurality of image-forming elements.

7. A method according to claim 6, wherein said individually controlling thermal energy provided to at least one of the plurality of image-forming elements includes ensuring the provision to at least one of the plurality of image-forming elements of sufficient thermal energy to form at least a sub-portion of an image pixel on the media with the at least one of the plurality of image-forming elements.

8. A printhead comprising:
at least one image-forming element configured to actuate between a printing position and a non-printing position relative to said printhead,
wherein said printhead is configured to be incorporated into a printer for processing media such that said at least one image-forming element is configured to transfer energy to the media when said at least one image-forming element is in the printing position, and said at least one image-forming element is configured to inhibit energy transfer to the media when said at least one image-forming element is in the non-printing position.

9. A printhead according to claim 8, wherein said at least one image-forming element is configured to be in one of contact or proximity with the media when said at least one image-forming element is in the printing position, and said at least one image-forming element is configured to be spaced apart from the media when said at least one image-forming element is in the non-printing position.

10. A printhead according to claim 8, wherein said at least one image-forming element is further configured to communicate with an energy source.

11. A thermal printhead according to claim 8, wherein said at least one image-forming element includes a plurality of image-forming elements, each element of said plurality of image-forming elements being configured to independently actuate between respective printing and non-printing positions.

12. A printhead according to claim 10, wherein each of said plurality of image-forming elements is configured to be heated to a sufficient temperature and to have sufficient heat capacity to image thermal media when disposed in the printing position.

13. A printhead according to claim 8, wherein said at least one image-forming element includes at least one of an actuating lever, a mechanically-actuated energy shutter, or a microvalve configured to communicate with a temperature bath.

14. A printhead according to claim 13, wherein said at least one actuating lever, mechanically-actuated energy shutter, or a microvalve is part of a micro-electromechanical system.

15. A printhead according to claim 13, wherein said at least one actuating lever, mechanically-actuated energy shutter, or a microvalve is associated with a piezoelectric actuator.

16. A printhead according to claim 10, wherein each of said plurality of image-forming elements respectively includes at least one of a mechanically-actuated energy shutter or a microvalve configured to be selectively opened when a colored pixel is desired to be imaged on the media.

17. A printhead according to claim 16, wherein each of said respective mechanically-actuated energy shutters and microvalves is configured to actuate by an amount that is individually selectable and controllable.

18. A printhead according to claim 10, further comprising at least one of an optical device or a contact pressure sensor.

19. A printhead according to claim 8, wherein said at least one image-forming element comprises at least two sub-image forming elements, said at least two sub-image forming elements being configured such that at least one of said at least two sub-image forming elements can be positioned in the printing position, while all of said at least two sub-image forming elements other than said at least one of said at least two sub-image forming elements are positioned in the non-printing position.

20. A printhead according to claim 19, wherein said at least one of said at least two sub-image forming elements includes multiple sub-image forming elements that can be simultaneously positioned in the printing position.

21. A printhead according to claim 8, wherein said at least one image-forming element comprises at least two sub-image forming elements, and wherein each of said at least two sub-image forming elements is configured to contain sufficient thermal energy to form at least a sub-portion of an image pixel on thermal media.

22. A printhead according to claim 8, wherein said at least one image-forming element comprises at least two sub-image forming elements, and wherein each of said at least two sub-image forming elements is configured to form at least a sub-portion of an image pixel on thermal media.

23. A printhead according to claim 8, wherein said at least one image-forming element includes an energy source.

24. A printhead according to claim 8, wherein said at least one image-forming element includes a structure selected from the group consisting of: an electron beam emitter, an ion beam emitter, a gas jet, and a plasma jet.

25. A printer comprising:
a printhead including at least one image-forming element configured to communicate with an energy source and to actuate relative to said printhead between a printing position and a non-printing position; and
a media handling system configured to manipulate media into an imaging position with respect to the printhead,
wherein said printer is configured such that said at least one image-forming element is configured to transfer energy to the media when said at least one image-forming element is in the printing position, and said at least one image-forming element is configured to inhibit energy transfer to the media when said at least one image-forming element is in the non-printing position.

26. A printer according to claim 25, wherein said at least one image-forming element is configured to be in one of contact or proximity with the media when said at least one image-forming element is in the printing position, and said at least one image-forming element is configured to be spaced apart from the media when said at least one image-forming element is in the non-printing position.

27. A printer according to claim 25, further comprising an energy source in communication with said at least one image-forming element.

28. A printer according to claim 27, wherein said energy source includes a system configured to support combustion of a liquefied gas selected from the group consisting of: butane, propane, and natural gas.

29. A printer according to claim 27, wherein said energy source includes a system configured to support combustion of a liquid hydrocarbon fuel selected from the group consisting of: gasoline, ethanol, methanol, and nitromethane.

30. A printer according to claim 27, wherein said energy source includes a source of radiant energy selected from the group consisting of: ultraviolet radiation, infrared radiation, and radio-frequency energy.

31. A printer according to claim 27, wherein said energy source includes a source selected from the group consisting of: a convective heated gas source and a plasma source.

32. A printer according to claim 26, wherein said at least one image-forming element includes a plurality of image-forming elements that are one of commonly or individually heated.

33. A printer according to claim 27, wherein said energy source is integrated with said printhead.
